(19) United States
(12) Patent Application Publication
(10) Pub. No.: US 2002/0100026 A1
(43) Pub. Date: Jul. 25, 2002

(54) System and method for generating machine-language code from readable text code for information filtering

(76) Inventors: Robert Betros, San Diego, CA (US); Mansour Raad, Winchester, MA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/766,383

(22) Filed: Jan. 19, 2001

(51) Int. Cl. G06F 9/45

(52) U.S. Cl. 717/136

(57) ABSTRACT

A system and method for generating and executing machine-language filter code. A filter generator receives a text-based filter string. The filter string contains filter criteria for filtering messages communicated from one computer program to another computer program or to the same computer program. A machine language generator converts the filter string to a machine-language filter code. A central processing unit of a host loads and executes the machine-language filter code to process or discard messages based on the filter criteria. The machine-language filter code is maintained by the computer program for continual reuse eliminating the interpretation and translation of the filter string from data to code for each message.

### BACKGROUND OF THE INVENTION

1. Field of the Invention

This invention relates to computer communications, and more particularly to machine-language code generation for filtering information communicated between computer program operations.

2. Description of the Related Art

A host is a physical machine having operating system software that manages one or more other computer programs that reside on the physical machine. A computer program includes one or more software components that work together to perform the logic of the program. Each computer program can communicate information with other computer programs on the same host or on a different host. A unit of information to be communicated is referred to as a payload. Before transmission, the payload is supplemented with one or more properties. Properties include data for identifying information within and about the payload. A message represents a combination of the properties and the payload.

A computer program includes a code section and a data section. The code section contains machine-language code, which is a sequence of byte values that are arranged in such a way to be executed directly by the central processing unit (CPU) of the host, to perform a specific task. The data section is a sequence of byte values, that is used to store data structures required by the computer program. The data section byte values may or may not be arranged in machine-language code.

An important mechanism for efficient communication of messages from one computer program to another is a filter, by which messages of interest are communicated and all other messages are discarded. A filter string is a text-based expression of logic that is readable by a human user, and which is executed by a computer program for performing a filtering task. One example of a filter string is a Boolean logic expression that includes Boolean operators such as “and” or “or” and references to the message properties and or the payload. Computer programs can include one or more filters to execute the Boolean logic expression on each received message to determine if the message should be processed or disregarded by the computer program.

Typically, when a computer program performs filtering, a filter generator is used. The filter generator accepts a filter string and reorganizes the filter string into a data structure. The data structure represents the filter string, and is stored in the data section of the computer program employing the filter. Typically, the filter string is represented as a tree structure. Each time a new message is received by the computer program, the data structure representing the filter string is retrieved from the data section and is interpreted to execute machine-language code specific to the host machine in which the computer program resides. Since the machine-language code is specific to a particular type of host, it is an effective means of filtering messages.

However, the interpretation of the data structure created from the filter string to execute the machine-language code is required for every message and adds significant processing delay, especially when a large volume of messages are being received by an computer program.

### SUMMARY OF THE INVENTION

The aforementioned problems are overcome with a message filtering system and method that converts the filter string directly into machine-language code once for reuse on multiple messages, thereby eliminating the intermediate step of interpreting the filter string representation to execute the appropriate machine-language code on each message. In accordance with one embodiment of the invention, a method of filtering information transmitted from one computer program to another computer program or to the same computer program includes receiving a textbased filter string representing filter criteria, and converting the filter string directly into machine-language code. The embodiment further includes loading the machine-language code into a computer program to accept or discard information based on the filter criteria.

In accordance with an alternative embodiment of the invention, a system of filtering information transmitted from one computer program to another computer program or to the same computer program includes a filter generator configured to receive a text-based filter string representing filter criteria, and a machine-language code generator coupled with the filter generator and being configured to convert the filter string to machine-language code. The system further includes a mechanism by which the machine-language code is loaded into a computer program. Once loaded into the computer program, the machine-language code is termed machine-language filter code and is continually executed to accept or discard information based on the filter criteria.

### BRIEF DESCRIPTION OF THE DRAWINGS

FIG. 1 shows a message filtering system according to one embodiment of the invention.

FIG. 2 shows a method for filtering messages according to an embodiment of the invention.

### DETAILED DESCRIPTION OF THE PREFERRED EMBODIMENTS

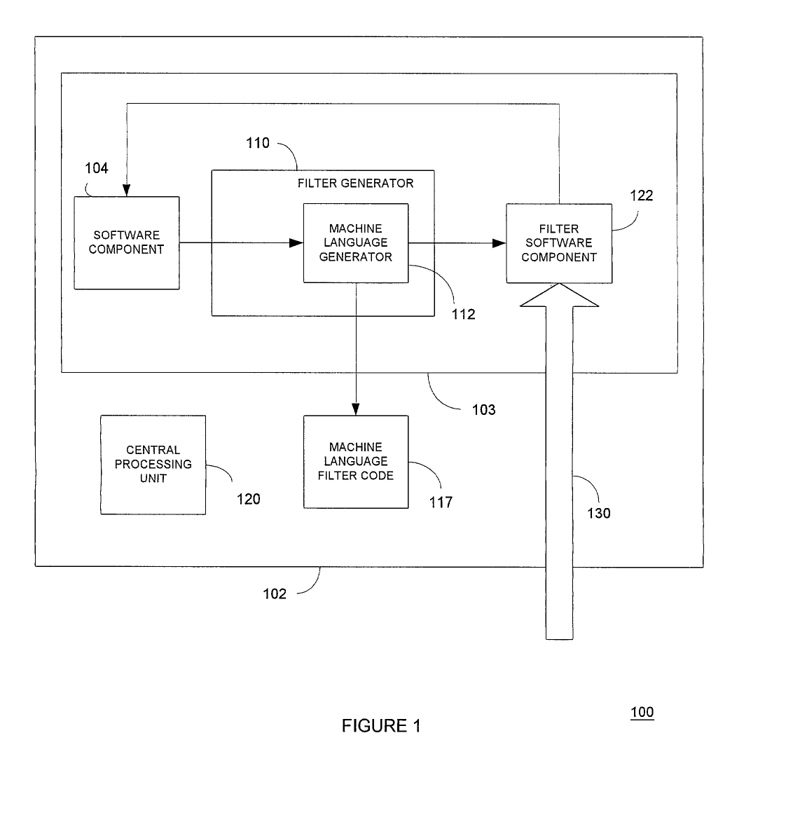

FIG. 1 shows a system 100 for generating machine-language code for message filtering. System 100 preferably includes a host 102. The host 102 represents a physical machine having a central processing unit (CPU) 120 and an operating system software that manages one or more computer programs that reside on the physical machine and which are executed by the CPU 120.

A computer program 103 includes one or more software components 104. In accordance with an embodiment of the invention, one such software component is a filter generator 110. The filter generator 110 accepts filter strings from a software component 104. The filter string defines an acceptance criteria by which the software component 104 processes or discards messages.

In one embodiment, filter strings are expressed in a text-based format that is readable by a human user, and whose syntax is based on the Structured Query Language (SQL) conditional expression syntax. The text can include, without limitation, one or more expressions separated by a Boolean operator such as “and” or “or” for example. Each expression is made up of two elements separated by a Boolean conditional operator such “less-than” or “greater-than.” One element of the expression can be a numerical or functional value, or can be a reference to an element in the message.

The filter generator 110 includes a machine-language code generator 112. The filter generator 110 reorganizes each submitted filter string into a format that is acceptable to the machine-language code generator 112. The machine-language code generator 112 accepts the newly formatted filter string as an input, and generates machine language filter code 117. The machine language filter code 117 is then loaded into the computer program 103 to produces a filter software component 122 in machine-language code, which can be directly executed by the CPU 120 of the host 102.

According to an exemplary embodiment, the machine-language code generator 112 represents a Java™ compiler, the computer program 103 represents a Java virtual machine (JVM), and the software component 104 is a Java class. The filter generator 110 accepts a filter string as an input, from which it generates a Java™ text file that defines a Java™ class, which implements a predefined filter interface definition.

The filter interface definition calls for the implementation of a function that returns a Boolean value and expects as an argument an implementation of a predefined message interface definition. The message interface definition is empty to enable the generalization of the filter to any specific message implementation. The returned Boolean value indicates to the software component 104 if the received message should be processed or disregarded.

The Java™ text file is compiled by the Java™ compiler 112 to produce a Java™ class 117. The Java™ class 117 is loaded into the computer program 103to produce the filter software component 122 for message filtering. Accordingly, each time a message 130 is received by the computer program 103, the filter software component 122 evaluates the received message 130 by applying the filter criteria to the message and instructs the software component 104 to either process the message 135, or reject the message 130.

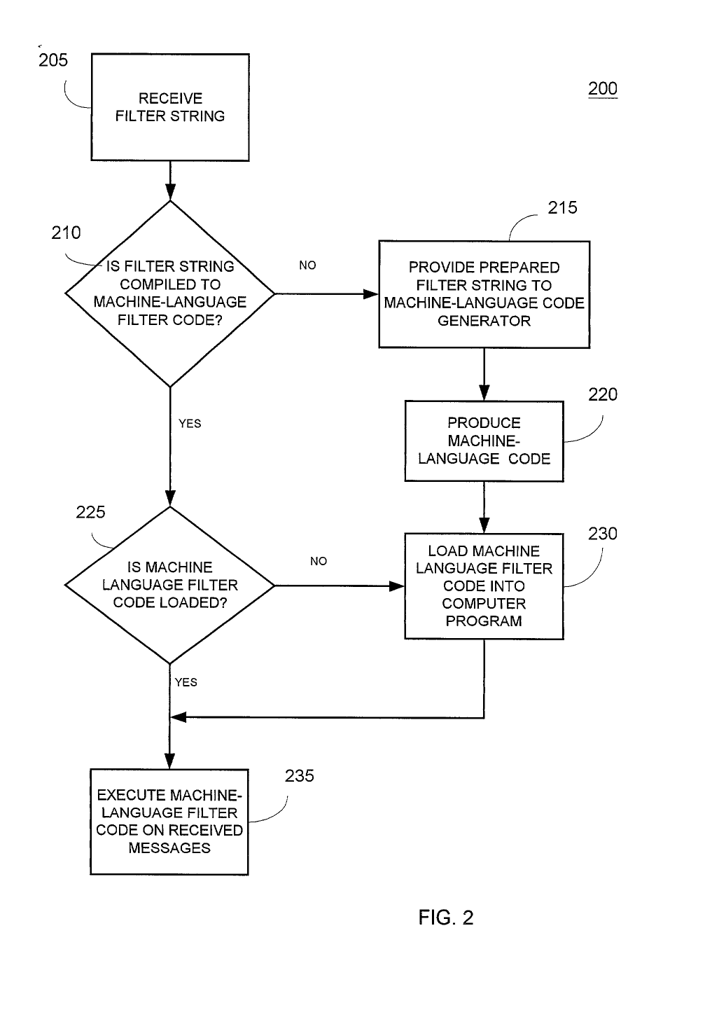

FIG. 2 is a flowchart illustrating a method 200 according to an embodiment of the invention. The method 200 can be executed at other functional levels of a computer system. At block 205, a filter string is received. The filter string may be received from a separate computer program residing on another host, or the same host, or from within a single computer program. The filter string is in a text-based format that is readable by a human user and whose syntax is based on the SQL conditional expression syntax.

At block 210, a determination is made whether the filter string requires conversion into machine-language filter code. The conversion into machine-language filter code is required if there is no recollection of a recently-performed translation of a similar filter string. If conversion is required, at block 215, the text-based filter string is prepared for the machine-language code generator. At block 220, the prepared filter string is converted into machine-language code by the machine-language code generator. If the conversion is not required, at block 225, a determination is made whether the machine-language filter code is already loaded into the computer program.

If the machine-language filter code is not loaded, then at block 230 the machine-language code is loaded into the computer program. At block 235, the computer program with the filter software component is executed on multiple incoming messages. Accordingly, the multiple incoming messages are evaluated against the filter criteria represented in the filter software component, to process or discard messages in the specified manner.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A method of filtering messages, comprising:
receiving a text-based filter string representing filter criteria;
converting the text-based filter string directly to machine-language filter code once for use by a code section of a computer program; and
using the code section, executing the machine-language filter code to accept or discard multiple messages received by or residing within one or more software components within the computer program based on the filter criteria.

2. The method of claim 1, wherein executing the machine-language filter code is performed by a central processing unit running the computer program.

3. The method of claim 2, wherein the computer program is a Java virtual machine.

4. The method of claim 1, wherein the machine-language filter code is directly executable by the central processing unit.

5 The method of claim 4, wherein the machine-language filter code is a Java™ class.

6. The method of claim 1, wherein the text-based filter string is human-readable.

7. The method of claim 6, wherein the text-based filter string is formatted according to a conditional expression syntax.

8. A system of filtering information transmitted from one or more software components within a computer program to one or more other software components within another computer program or the same computer program, comprising:
a filter generator configured to receive a text-based filter string representing filter criteria;
a machine language generator coupled with the filter generator and being configured to convert the text-based filter string directly to machine-language filter code; and
a processor for executing the machine-language filter code for a software component of a computer program to accept or discard information received by the software component within the computer program based on the filter criteria.

9. The system of claim 8, wherein the processor is included with a central processing unit.

10. The system of claim 8, wherein the computer program is a Java™ virtual machine.

11. The system of claim 8, wherein the machine-language filter code is directly executable by the central processing unit.

12 The system of claim 11, wherein the machine-language filter code is a Java™ class.

13. The system of claim 8, wherein the filter string is human readable.

14. The system of claim 13, wherein the filter string is formatted according to a conditional expression syntax.
